(19) United States
(12) Patent Application Publication
(10) Pub. No.: US 2007/0290818 A1
(43) Pub. Date: Dec. 20, 2007

(54) Method of Transmitting Monitoring Information

(75) Inventors: Simon Poskett, Glocestershire (GB); Ian Clarke, West Sussex (GB); David John Clark, West Sussex (GB); Dean Garland, West Sussex (GB); Stuart King, West Sussex (GB); Alex J. Marshall, West Sussex (GB); Ross Peters, Sussex (GB); Martin Pointer, West Sussex (GB)

Correspondence Address: OSHA LIANG L.L.P., 1221 MCKINNEY STREET, SUITE 2800, HOUSTON, TX, 77010, US

(73) Assignee: RICARDO UK LIMITED, West Sussex United Kingdom (GB)

(21) Appl. No.: 10/578,486

(22) PCT Filed: Nov. 5, 2004
(86) PCT No.: PCT/GB04/04680

§ 371 Date: Apr. 6, 2007

(30) Foreign Application Priority Data
Nov. 5, 2003 (GB) 0325859.7

(51) Int. Cl. B60R 25/10

(52) U.S. Cl. 340/425.5

(57) ABSTRACT

In order to transmit information relating to vehicle or vehicle component testing or monitoring at a test site, the test information is processed for example in a computer memory and the resulting image signal is sent via a transmission medium to a remote terminal where it is reconstructed. As a result only the image signal is sent requiring reduced bandwidth.

The invention relates to a method of transmitting monitoring information for example data relating to tests performed on vehicles or vehicle components in a test cell.

Test cells are used for real-time vehicle or vehicle component testing for example in relation to vehicle engines, vehicle chassis, vehicle transmissions or other vehicle components.

In the case, for example, of vehicle engines, a test development engineer defines a test to be carried out on an engine, for example identifying the parameters that are to be tested and the testing regime that may define a duty cycle through which the engine is run.

During testing the engine is run in a test cell such as a specifically designated testing room, according to the duty cycle, and control data and engine performance output data is continually controlled, managed and monitored in real time. The test conditions and outputs are controlled by one or more computers. For example different computers may have different assigned tasks such that one may control the physical inputs to the engines such as throttle and engine load, another the control parameters of an engine management system controlling the engine such as ignition timing and fuel injectors and another will provide data acquisition in terms of the performance outputs from the engine such as stress, strain, temperature, torque or emissions as appropriate. Each computer will have one or more applications with their own graphical user interface (GUI) allowing monitoring and control of the various test parameters.

Generally, the computers will be physically adjacent to the test cell for health and safety reasons allowing direct physical intervention in the test if necessary. Control and monitoring of the tests is carried out by one or more test technicians at the test site. However, in some instances it is desirable for a third party at a remote location to have the ability to review the test. For example where the on-site test technician recognises that the test is not running correctly it may be necessary to contact the remote test development engineer to assess whether the test can be modified appropriately.

In one known remote monitoring system, output data from the vehicle or vehicle component in the test cell is transmitted to a client terminal at a remote site as monitoring information. The data is processed at the remote client and represented on a remote client computer. A problem with the known system is that this requires significant amount of data to be transmitted in real time which can give rise to bandwidth difficulties. In addition sophisticated software is required at the client terminal to interpret and represent the received data in a user readable form.

The invention is set out in the claims.

Embodiments of the invention will now be described by way of example with reference to the drawings of which:

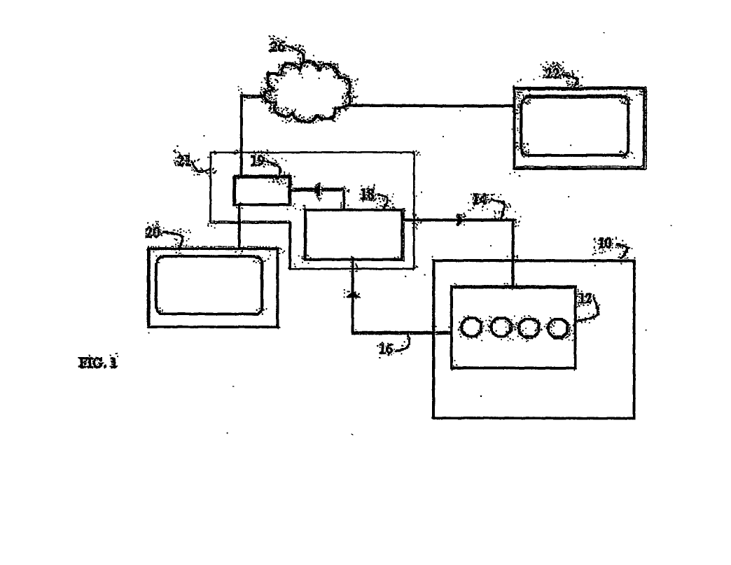

FIG. 1 is a block diagram showing the principle components of an apparatus for remote monitoring of test data; and

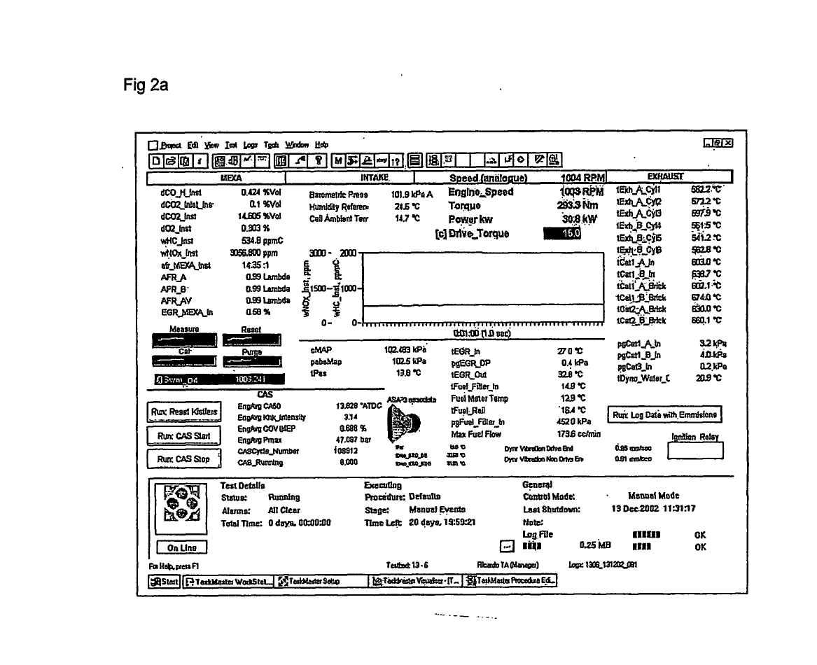

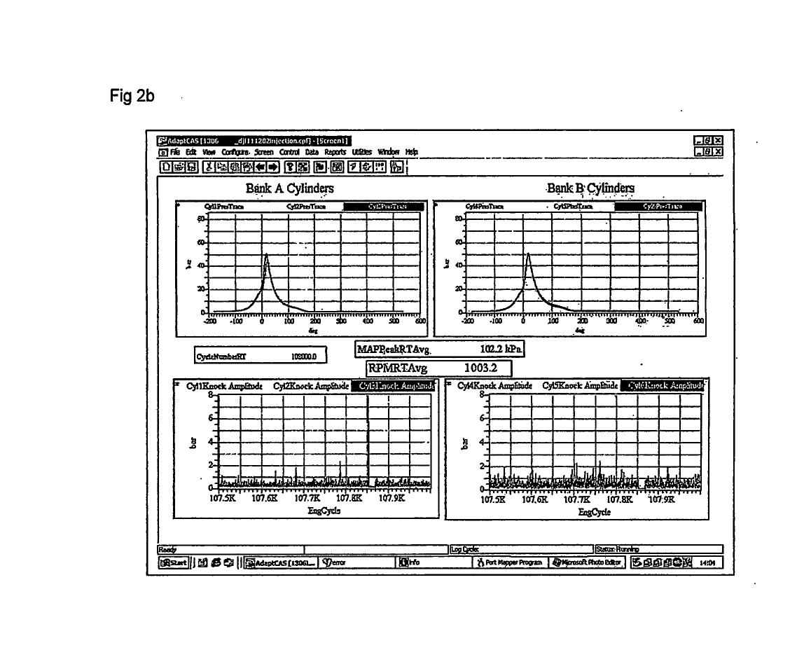

FIGS. 2a and 2b are representations of a typical screens representing parameters of the test.

In overview, data collated during testing or monitoring of for example an engine is logged and processed at a computer such as a local or host terminal and represented on a monitor or user screen by a graphical user interface (GUI).

In order to allow remote access, instead of transmitting the raw data received from the control processor or engine sensors or outputs, an image of the user's screen is transmitted to the remote client. This can be done, for example, by transmitting the image definition from the local computer directly to the remote client computer monitor such that the user's screen is mirrored on site and at the remote terminal. In particular a human viewable representation signal can be transmitted, for example that generated or received by the graphics card. As a result all information available to the local technician is also available remotely, allowing real-time collaboration between the test technician and development engineer. Significantly less bandwidth is required to achieve this because of the approach adopted, and it is not necessary to load sophisticated interpretation software at the remote client.

In an optimisation, however, additional software can be loaded at the remote client to allow further analysis of the data represented on the screen. Yet further, control of the test can be slaved to the remote client terminal.

Referring to FIG. 1 a test cell designated generally (10) includes an engine (12) having a control input (14) and a performance data output (16). A computer (21) including a processor (18) and a graphics card (19) which can be any appropriate computer such as a personal computer (PC) or other processor controls testing of the engine by sending control input (14) and monitoring performance via performance data outputs (16) from respective test cells or engine sensors (not shown). Although a single computer is shown it will be appreciated that multiple processors can be used both for sending control information and receiving performance data. For example respective individual processors can be used for controlling the engine directly and also for controlling the engine management system (not shown). Similarly separate processors can receive performance data of different types. As a result real time control and monitoring of the engine (12) in a test cell (10) can be carried out. The processor (18) further outputs an image signal to the graphics card (19). On the basis of the received signal the graphics card produces an image signal to a local monitor (20) showing relevant control and performance data to an on-site test technician.

In order to enable remote monitoring or control of the test cell (10) the computer system and processor (18) also transmits a human viewable representation signal to a remote computer (22). The signal can be transmitted over any appropriate medium (26) such as a telephone line, LAN, private network or the internet, or any other appropriate transmission medium. The signal can be, for example, the image signal received by the graphics card (19) from the processor (18), or the image signal from the graphics card (19).

It will be seen that any appropriate computer showing relevant information can be accessed appropriately. For example computers showing basic engine control data, engine management system or engine control unit control data or engine performance data such as combustion analysis or emissions can be displayed on the local display or at the remote client computer display. In addition, any other information relating to the test can be shown for example post-processing information. For example FIG. 2A shows control and acquisition information such as engine speed, torque, power, pressure, fuel rate and so forth. FIG. 2B shows a combustion analysis where cylinder pressure traces are provided for each cylinder and engine cycle together with cylinder knock amplitude for each cylinder across multiple engine cycles. Of course any other appropriate screen can be represented. In addition the computer can include control aspects such as clickable screen buttons allowing resetting of the various sensors, running of additional tests and so forth allowing the test technician to vary parameters of the test.

Accordingly, by sending an image signal directly from the computer memory (21) to the remote monitor (22) it will be seen that all of the relevant information available to the technician can also be available to the test development engineer. Yet further control of the test can be slaved to the remote monitor for example under the control of a button on the test technician's screen such that the test can be controlled remotely as well.

It will be appreciated that the method and apparatus described can be implemented in any appropriate form. Any appropriate computer system such as a Windows™ based PC (operating systems would include Windows 98, Windows NT, Windows 2000) can be used both locally and remotely where the screen image is taken directly from the host PC's memory and transported down the network, where it is interpreted by the remote computer and then displayed as a screen image, or taken from the graphic (video) card. Any appropriate testing package can be used as well, such as any Windows™ based real-time testing software. It will be appreciated that the invention extends to any type of vehicle test or monitoring including performance tests and vehicle calibration and that generally the term “monitoring” in relation to vehicle or other information embraces test information or data, monitoring information or data and other measures for obtaining real-time information concerning an operation or process for example data such as computer generated data representing progress or performance thereof.

The image can be transmitted over any appropriate network and if a public network such as the internet is used then any appropriate security protocol can be added on, such as HTTPS. At the remote client and no dedicated additional software need be incorporated; any appropriate internet browser, for example, can be used to allow display of the user screen remotely. Similarly the ability to control the test from the remote location can be slaved using any appropriate software and protocols. Furthermore the screen could be transmitted in any alternative manner, for example by capturing screen shots and transmitting them at an appropriate refresh rate. The data received at the remote client whether from the graphics card or any other means is pure image data but can be reversed compiled with appropriate software installed at the remote client. It will further be noted that both the test technician and test development engineer can be at the same or different remote sites allowing testing to be controlled and monitored purely remotely.

1. A method of transmitting monitoring information from a monitoring site to a remote site, comprising receiving monitoring information at the monitoring site, processing the monitoring data to form a human viewable representation signal and transmitting the human viewable representation signal to a remote site.

2. A method as claimed in claim 1 further comprising receiving the human viewable representation signal at a remote site and displaying the signal as a human viewable representation.

3. The method as claimed in claim 2 further comprising transmitting control instructions from the remote site to the monitoring site.

4. The method as claimed in claim 2 further comprising processing the human viewable representation at the remote site to derive monitoring data.

5. The method as claimed in claim 1 in which the monitoring information is processed to form a human viewable representation signal by computer.

6. A method of receiving monitoring information from a monitoring site at a remote site comprising receiving, at the remote site, a human viewable representation signal representing the monitoring information and displaying the human viewable representation of that monitoring signal.

7. The method as claimed in claim 1 in which the monitoring information is test information for example vehicle or vehicle component monitoring data.

8. A computer program comprising a set of instructions configured to implement a method as claimed in claim 1.

9. A computer configured to run under the instructions of a computer program as claimed in claim 8.

10. A computer readable medium storing a computer program as claimed in claim 8.

11. The method as claimed in claim 3 further comprising processing the human viewable representation at the remote site to derive monitoring data.

12. The method as claimed in claim 2 in which the monitoring information is processed to form a human viewable representation signal by computer.

13. The method as claimed in claim 3 in which the monitoring information is processed to form a human viewable representation signal by computer.

14. The method as claimed in claim 4 in which the monitoring information is processed to form a human viewable representation signal by computer.

15. The method as claimed in claim 11 in which the monitoring information is processed to form a human viewable representation signal by computer.

16. The method as claimed in claim 6 in which the monitoring information is test information for example vehicle or vehicle component monitoring data.

17. A computer program comprising a set of instructions configured to implement a method as claimed in claim 6.

18. A computer configured to run under the instructions of a computer program as claimed in claim 17.

19. A computer readable medium storing a computer program as claimed in claim 17.
